(19) United States
(12) Patent Application Publication
(10) Pub. No.: US 2025/0317567 A1
(43) Pub. Date: Oct. 9, 2025

(54) CONSTITUENT RECTANGLES IN CODED VIDEO

(71) Applicant: Nokia Technologies Oy, Espoo (FI)

(72) Inventors: Jill BOYCE, Portland, OR (US); Miska Matias HANNUKSELA, Tampere (FI)

(21) Appl. No.: 19/171,867

(22) Filed: Apr. 7, 2025

Related U.S. Application Data
(60) Provisional application No. 63/631,286, filed on Apr. 8, 2024.

(51) Int. Cl. H04N 19/132; H04N 19/167; H04N 19/172; H04N 19/70

(52) U.S. Cl. CPC H04N 19/132; H04N 19/167; H04N 19/172; H04N 19/70

(57) ABSTRACT

An example apparatus includes: at least one processor; and at least one memory storing instructions that, when executed by the at least one processor, cause the apparatus at least to: form a composite picture from a composition of one or more constituent rectangles; code the composite picture to form a coded composite picture; and signal information related to the composite picture within a supplemental enhancement information message.

### TECHNICAL FIELD

The examples and non-limiting embodiments relate generally to multimedia transport and, more particularly, to constituent rectangles in coded video.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows an example picture with texture and depth constituent rectangles.

FIG. 2 shows an example picture with constituent rectangles for multi-view with 3 views.

FIG. 3 shows schematically a user equipment suitable for employing embodiments of the examples described herein.

FIG. 4 is a block diagram illustrating a system in accordance with an example.

FIG. 5 is an example apparatus configured to implement the examples described herein.

FIG. 6 shows a representation of an example of non-volatile memory media used to store instructions that implement the examples described herein.

FIG. 7 shows an encoder according to an embodiment.

FIG. 8 shows a decoder according to an embodiment.

FIG. 9 is an example method, based on the examples described herein.

FIG. 10 is an example method, based on the examples described herein.

FIG. 11 is an example method, based on the examples described herein.

FIG. 12 is an example method, based on the examples described herein.

### DETAILED DESCRIPTION OF EXAMPLE EMBODIMENTS

Auxiliary pictures such as alpha or depth may be associated with another picture. Alpha indicates the degree of transparency of a picture. Depth indicates distance from a camera.

Some applications may benefit from having coded pictures that contain multiple constituent rectangles containing auxiliary pictures or AI features.

### Motion-Constrained Picture Partitioning

The prefix motion-constrained may be used to indicate that the associated picture partitioning unit is independent of other picture partitioning units in the same picture and non-collocated picture partitioning units in reference pictures. Motion-constrained picture partitioning units may be achieved through encoding selections wherein the encoder selects parameters, such as motion vectors, that avoid dependencies between picture partitioning units, or through in-loop handling of picture partitioning units in the encoder and the decoder, such as exemplified with independent subpictures of VVC. The prefix motion-constrained may include disabling in-loop filtering across the boundaries of the associated picture partitioning unit. Some examples of motion-constrained picture partitioning are described below.

In some video coding formats, such as VVC, a subpicture may be defined as a rectangular region of one or more slices within a picture, wherein the one or more slices are complete. Thus, a subpicture includes one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices. One or both of the following conditions may be required to be fulfilled for each subpicture and tile: i) all CTUs in a subpicture belong to the same tile; ii) All CTUs in a tile belong to the same subpicture.

One or both of the following conditions may be required to be fulfilled for each subpicture and tile: i) All CTUs in a subpicture belong to the same tile. ii) All CTUs in a tile belong to the same subpicture.

An independent VVC subpicture is treated like a picture in the VVC decoding process. When the motion compensation would reference a sample location outside of boundaries of an independent VVC subpicture, the sample location is saturated to be within the subpicture. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A motion-constrained tile set (MCTS) is such that the inter prediction process is constrained in encoding such that no sample value outside the motion-constrained tile set, and no sample value at a fractional sample position that is derived using one or more sample values outside the motion-constrained tile set, is used for inter prediction of any sample within the motion-constrained tile set. Additionally, the encoding of an MCTS is constrained in a manner that motion vector candidates are not derived from blocks outside the MCTS. This may be enforced by turning off temporal motion vector prediction (TMVP), where TMVP may be specified like in HEVC, for example, or by disallowing the encoder to use the TMVP candidate or any motion vector prediction candidate following the TMVP candidate in a motion vector prediction list, such as the merge or AMVP candidate list as specified in HEVC, for prediction unit located directly left of the right tile boundary of the MCTS except the last one at the bottom right of the MCTS. In general, an MCTS may be defined to be a tile set that is independent of any sample values and coded data, such as motion vectors, that are outside the MCTS. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures.

Described herein is a mechanism to enable coded pictures formed from a composition of multiple constituent rectangles. The constituent rectangles may be of different content types, such as texture, depth, alpha, object mask, or AI features.

The VSEI video coding standard provides a scalability dimension indication SEI message that enables to indicate that a layer of a coded video bitstream is an auxiliary picture and to identify the layer's auxiliary ID as alpha or depth.

In the HEVC standard video parameter set (VPS) extension, AuxId may be indicated for a non-primary layer in a multi-layer bitstream, for alpha or depth.

The frame packing arrangement SEI message in VSEI, HEVC, and AVC enables to indicate that two constituent pictures are packed within a single coded picture, in one of 3 arrangements: top-bottom, left-right, or temporally interleaved. The two constituent pictures can be identified as being left and right stereo views.

The V3C standard (ISO/IEC 23090-5) enables packing of different components (such as occupancy, geometry, and/or attribute) into the same coded picture. If several components are present in one video frame, the information on packing are provided by packed video extension of V3C Parameter Set (subclauses 8.3.4.7 and 8.3.4.9 of V3C). The syntax that indicates the type of the region is pin_region_type_id_minus2.

V3C packing and signaling volumetric video components may be performed in one video frame.

The examples described herein enable use of a standard video codec to encode pictures formed from a composition of multiple constituent rectangles using a Constituent rectangles SEI message. The rectangles may themselves be constituent pictures of different types, such as texture, depth, alpha, or object mask, or may contain multiple constituent pictures of the same type, such as multiple views or multiple AI feature channels.

Described herein is a constituent rectangles SEI message for VSEI to enable coded pictures formed from a composition of multiple constituent rectangles. The constituent rectangles may be of different content types, such as texture, depth, alpha, or object mask. Each constituent rectangle can also optionally be described by a text descriptor.

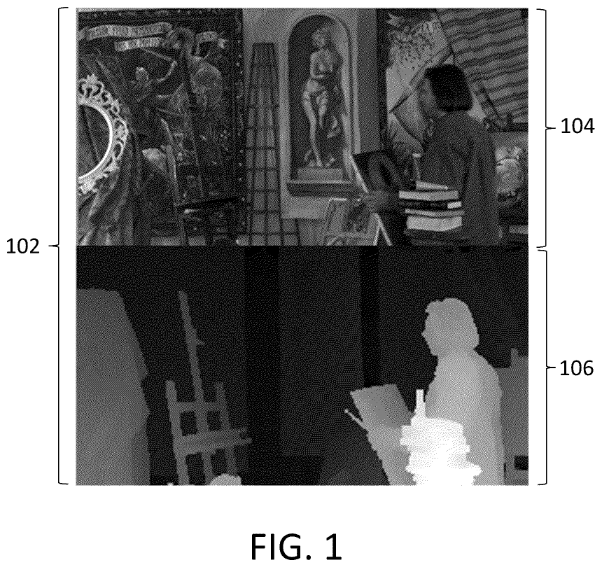

FIG. 1 shows an example coded picture 102 containing both a (normal video) texture constituent picture 104 and a depth constituent picture 106.

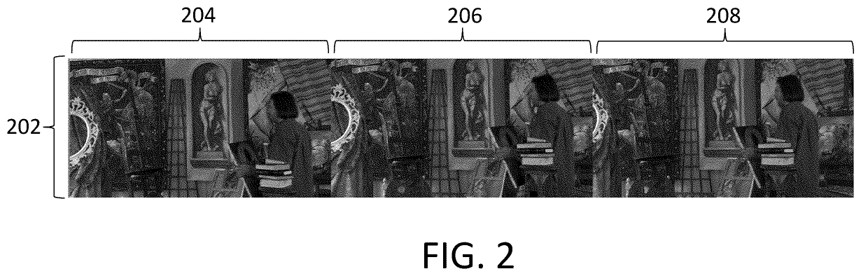

FIG. 2 shows a multi-view example, with a coded picture 202 containing 3 views, namely view 204, view 206, and view 208.

Although VVC can already support these use cases through the use of features such as multi-layer bitstreams and auxiliary pictures, some applications may prefer to use single layer bitstreams to simplify system timing and utilize existing VVC HW decoders.

Aspects of the herein described design are as follows:
A rect type is optionally signalled per constituent rectangle
Locations and sizes of the constituent rectangles can be signalled through the following options: subpic parameters signalled in the SPS may be used to identify the constituent rectangle locations and sizes, optional signalling of number of columns and rows when all constituent rectangles are the same size, with derivation of constituent rectangle locations and sizes, and explicit signalling of constituent rectangle location and sizes, in any order.
Each sample location in the coded picture may be included in at most one constituent rectangle, e.g. rectangles in the coded picture do not overlap.
Samples in the coded picture are not required to be in a constituent rectangle
An “empty” rect type can be signalled for a rectangular region, especially useful for vacant areas using “same size” signalling.
A rect ID is optionally signalled per constituent rectangle.
A rect description is optionally signalled per constituent rectangle.
SEI persists for an entire CLVS.
If adaptive resolution change is used, signalled constituent rectangle sizes and locations are for max pic width/height signalled in SPS, and current picture sizes and locations are calculated

### Syntax & Semantics

### VSEI

| | Descriptor |
|---|---|
| constituent_rectangles( payloadSize ) { | |
| cr_num_rects_minus1 | u(12) |
| cr_rect_id_present_flag | u(1) |
| if ( cr_rect id_present_flag ) | |
| cr_rect_id_len | u(4) |
| cr_rect_type_enabled_flag | u(1) |
| cr_rect_type_descriptions_enabled_flag | u(1) |
| cr_subpics_partitioning_flag | u(1) |
| if( !cr_subpics_partitioning_flag ) { | u(1) |
| cr_rect_same_size_flag | u(1) |
| if ( cr_rect_same_size_flag ) { | |
| cr_num_cols_minus1 | ue(v) |
| cr_num_rows_minus1 | ue(v) |
| } else { | |
| cr_log2_unit_size | u(4) |
| cr_rect_size_len_minus1 | u(4) |
| } | |
| for( i = 0; i <= cr_num_rects_minus1; i++ ) { | |
| if ( cr_rect type_enabled_flag ) { | |
| cr_rect_type_present_flag[ i ] | u(1) |
| if ( cr_rect_type_present_flag[ i ] ) | |
| cr_rect_type_idc[ i ] | u(8) |
| } | |
| if ( cr_rect type_idc[ i ] != 255 ) { | |
| if ( cr_rect id_present_flag ) | |
| cr_rect_id[ i ] | u(v) |
| if ( cr_rect type_description_enabled_flag ) | |
| cr_rect_type_description_present_flag[ i ] | u(1) |
| } | |
| if( !cr_subpics_partitioning_flag && !cr_rects_same_size_flag ) { | |
| cr_rect_top_left_in_units_x[ i ] | u(v) |
| cr_rect_top_left_in_units_y[ i ] | u(v) |
| cr_rect_width_in_units_minus1[ i ] | u(v) |
| cr_rect_height_in_units minus1[ i ] | u(v) |
| } | |
| } | |
| if( cr_rect_type_descriptions_enabled_flag ) { | |
| while( !byte_aligned( ) ) | |
| cr_bit_equal_to_zero /* equal to 0 */ | f(1) |
| for( i = 0; i <= cr_num_rects_minus1; i++ ) | |
| if( rect_type_description_present_flag[ i ] ) | |
| cr_rect_type_description[ i ] | st(v) |
| } | |
| } | |

The constituent rectangles SEI message enables composition of multiple rectangles within a coded picture and provides information about the rectangles, including ID, type, text description, location, and size.

If this SEI message is present in any picture unit that is not the first picture unit of a CLVS in decoding order, a composition information SEI message with the same payload content shall be present in the first picture unit of the CLVS in decoding order.
cr_num_rects_minus1 plus 1 specifies the number of constituent rectangles for which information is signalled in the SEI message.
cr_rect_id_present_flag equal to 1 specifies that the cr_rect_id[i] syntax element is present in the SEI message. cr_rect_id_present_flag equal to 0 specifies that the cr_rect_id[i] syntax element is not present in the SEI message.
cr_rect_id_len specifies the length of the cr_rect_id[i] syntax element.
cr_rect_type_enabled_flag equal to 1 specifies that the cr_rect_type_present_flag[i] syntax element is present in the SEI message. cr_rect_type_enabled_flag equal to 0 specifies that the cr_rect_type_present_flag[i] syntax element is not present in the SEI message.
cr_rect_type_descriptions_enabled_flag equal to 1 specifies that the cr_rect_type_description_present_flag[i] syntax element is present in the SEI message. cr_rect_type_descriptions_enabled_flag equal to 0 specifies that the cr_rect_type_description_present_flag[i] syntax element is not present in the SEI message.
cr_subpics_partitioning_flag equal to 1 indicates that the subpic partitioning parameters in the SPS are used to determine the of constituent rectangle sizes and positions. cr_subpics_partitioning_flag equal to 0 indicates that determination of the constituent rectangle sizes and positions is not based on subpic partitioning parameters in the SPS.
cr_rect_same_size_flag equal to 1 indicates that all constituent rectangles have the same size and are arranged in a grid pattern. cr_rect_same_size_flag equal to 0 indicates that the size and positions of constituent rectangles may differ.
cr_num_cols_minus1 plus 1 and cr_num_rows_minus1 plus 1 specify the number of columns and rows, respectively, of the constituent rectangle grid when cr_rect_same_size_flag equal to 1.

The variable crNumCols is set equal to cr_num_cols_minus1+1.

The variable crNumRows is set equal to cr_num_rows_minus1+1.
cr_log 2_unit_size specifies a unit size used in variable calculations for the constituent rectangle parameters.

The variable crUnitSize is set equal to 1<<cr_log 2_unit_size.
cr_region_size_len_minus1 plus 1 specifies the length of syntax elements cr_rect_top_left_in_units_x[i], cr_rect_top_left_in_units_y[i], cr_rect_width_in_units_minus1[i], and cr_rect_height_in_units minus1[i].
cr_rect_type_present_flag[i] equal to 1 specifies that the cr_rect_type_idc[i] syntax element is present in the SEI message. cr_rect_type_present_flag[i] equal to 0 specifies that the cr_rect_type_idc[i] syntax element is not present in the SEI message.
cr_rect_type_idc[i] indicates the constituent picture type of the i-th rectangle from Table X. When not present and i equal to 0, the value of cr_rect_type_idc[i] is inferred to be equal to 0. When not present and i greater than 0, cr_rect_type_idc[i] is inferred to be equal to cr_rect_type_idc[i−1].

Table 1 shows a mapping of cr_rect_type_idc[i] to the type of constituent rectangle.

TABLE 1

| | | Type of |
|---|---|---|
| | | constituent |
| cr_rect_type_idc[i] | Name | rectangle |
| 0 | SPT_TEXTURE | Texture |
| 1 | SPT_ALPHA | Alpha plane |
| 2 | SPT_DEPTH | Depth picture |
| 3 | SPT_OBJECT_MASK | Object mask |
| 4 . . . 127 | | Reserved |
| 128 . . . 254 | | Unspecified |
| 255 | SPT_EMPTY | Empty |

cr_rect_id[i] indicates the ID of the i-th rectangle. The length of the syntax element is cr_rect_id_len bits. When not present, the value of cr_rect_id[i] is inferred to be equal to i.

It is a requirement of bitstream conformance that when j not equal to k, cr_rect_id[j] shall not be equal to cr_rect_id[k].
cr_rect_type_description_present_flag[i] equal to 1 specifies that the cr_rect_type_description[i] syntax element is present in the SEI message. cr_rect_type_description_present_flag[i] equal to 0 specifies that the cr_rect_type_description[i] syntax element is not present in the SEI message. When not present, the value of cr_rect_type_description_present_flag[i] is inferred to be equal to 0.
cr_rect_top_left_x[i] and cr_rect_top_left_y[i], when present, indicate the horizontal and vertical positions, respectively, of the top left position of the i-th constituent picture rectangle in luma samples.

The variables SubWidthC and SubHeightC are derived from ChromaFormatIdc.

It is a requirement of bitstream conformance that cr_rect_top_left_x[i] % SubWidthC shall be equal to 0 and cr_rect_top_left_y[i] % SubHeightC shall be equal to 0.
cr_rect_width_minus1[i] plus 1 and cr_rect_height_minus1[i] plus 1, when present, indicate the width and height, respectively, of the i-th constituent rectangle in luma samples. The length of the syntax elements are cr_rect_size_len_minus1+1.

The variables crRectTopLeftX[i] and crRectTopLeftY[i], representing the x and y location, respectively, and variables crRectWidth[i] and crRectHeight[i], representing the width and height, respectively, of the i-th constituent rectangle are derived as follows.

If cr_subpics_partitioning_flag is equal to 0 and cr_rect_same_size_flag is equal to 0, the following applies:
The variable crRectTopLeftX[i] is set equal to cr_rect_top_left_x[i]*crUnitSize
The variable crRectTopLeftY[i] is set equal to cr_rect_top_left_y[i]*crUnitSize
The variable crRectWidth[i] is set equal to (cr_rect_width_minus1+1)*crUnitSize

The variable crRectHeight[i] is set equal to (cr_rect_height_minus1+1)*crUnitSize

Otherwise, if cr_subpics_partitioning_flag is equal to 1, the following applies:
The variable crRectTopLeftX[i] is set equal to SubPicTopLeftX[i]
The variable crRectTopLeftY[i] is set equal to SubPicTopLeftY[i]
The variable crRectWidth[i] is set equal to SubPicWidth[i]
The variable crRectHeight[i] is set to equal to SubPicHeight[i]

Otherwise (cr_rect_same_size_flag is equal to 1), the following applies:
The variable crRectTopLeftX[i] is set equal to (i % crNumCols)*maxPicWidth/crNumCols
The variable crRectTopLeftY[i] is set equal to (i/crNumCols)*maxPicHeight/crNumRows
The variable crRectWidth[i] is set equal to maxPicWidth/crNumCols
The variable crRectHeight[i] is set to equal to maxPicHeight/crNumRows

When PicWidthInLumaSamples is not equal to MaxPicWidth, the following applies:

crRectTopLeftX[i] is set equal to (crRectTopLeftX[i]*PicWidthInLumaSamples+maxPicWidth/2)/MaxPicWidth
crRectWidth[i] is set equal to (crRectWidth[i]*PicWidthInLumaSamples+maxPicWidth/2)/MaxPicWidth

When PicHeightInLumaSamples is not equal to MaxPicHeight, the following applies:
crRectTopLeftY[i] is set equal to (crRectTopLeftY[i]*PicWidthInLumaSamples+maxPicHeight/2)/MaxPicHeight
crRectHeight[i] is set equal to (crRectHeight[i]*PicWidthInLumaSamples+maxPicHeight/2)/MaxPicHeight

It is a requirement of bitstream conformance that for each sample position (x, y) in the coded picture there shall be at most one rectangle, j, for which both of the following conditions apply:
x is in (crRectTopLeftX[j] . . . crRectTopLeftX[j]+crRectWidth[j]−1)
y is in (crRectTopLeftY[j] . . . crRectTopLeftY[j]+crRectHeight[i]−1)

The variables SubWidthC and SubHeightC are derived from ChromaFormatIdc.

It is a requirement of bitstream conformance that crRectTopLeftX[i] % SubWidthC shall be equal to 0, crRectTopLeftX[i] % SubHeightC shall be equal to 0, crRectWidth[i]] % SubWidthC shall be equal to 0, and crRectHeight[i]] % SubHeightC shall be equal to 0.
cr_bit_equal_to_zero shall be equal to 0.
cr_rect_type_description[i] specifies a text description of the constituent rectangle. The length of the ar_label[ar_label_idx[i]] syntax element shall be less than or equal to 4097 bytes, not including the null termination byte.

### VVC

### D.12.13 Use of the Constituent Rectangles SEI Message

For purposes of interpretation of the constituent rectangles SEI message, the following variables are specified:
PicWidthInLumaSamples and PicHeightInLumaSamples are set equal to pps_pic_width_in_luma_samples and pps_pic_height_in_luma_samples, respectively.
MaxPicWidth and MaxPicHeight are set equal to sps_pic_width_max_in_luma_samples and sps_pic_height_max_in_luma_samples, respectively.
ChromaFormatIdc is set equal to sps_chroma_format_idc.
BitDepthY and BitDepthC are both set equal to BitDepth.
SubPicTopLeftX[i] is set equal to sps_subpic_ctu_top_left_x[i]*CtbSizeY
SubPicTopLeftY[i] is set equal to sps_subpic_ctu_top_left_y[i]*CtbSizeY
SubPicWidth[i] is set equal to (sps_subpic_width_minus1[i]+1)*CtbSizeY−1
SubPicHeight[i] is set equal to (sps_subpic_height_minus1[i]+1)*CtbSizeY−1

### Variations

The above syntax and semantics describe using the cropped decoded picture, which is output. Alternatively, the decoded picture without cropping could be used.

A rectangle ID is optionally sent, based on a flag. The rectangle ID could be mandatory or could not be signalled and derived from the index order of the signalled rectangles. The rectangle ID may be signalled with u(v) coding with a signalled length. The rectangle ID could be signalled in other ways, such as ue(v) or a fixed length code.

The type of a constituent rectangle may be indicated by different means. In one alternative, the constituent rectangle types are defined using the same pre-defined type values as used for the auxiliary layer types (a.k.a. auxiliary ID or AuxId).

The constituent rectangles may represent AI feature channels, which may also be called feature maps. In this case, the coded picture likely contains many small rectangles, each representing a feature channel. For features, the type is likely all the same, so the type is inferred from the first signalled type. The rectangle ID varies for each rectangle. Feature channels may be packed into a coded picture in any order and the rectangle ID can be used to identify the channel. More efficient rectangle ID signalling could be used that takes advantage of the fact that a given feature channel is positioned at most once in the coded picture, so the number of bits to signal the rectangle ID could be reduced when the set of allowable rectangle ID values decreases, e.g. if there are 2\hat{ }n or fewer possible remaining channels, n bits may be used in the signalling a mapping of the ID.

A same size flag is signalled to enable more efficient signaling of constituent rectangle size and position when all constituent rectangles are the same size.

The rectangle position and size may be signaled using a unit size, but variations are possible. For example, the unit size could be predetermined and not signaled. Or, those parameters could be signaled without using a unit size, and instead in units of luma samples. The unit size may be signaled as a power of 2, but could alternatively be signalled another way, such as being directly signalled.

One option in the presented syntax and semantics is to indicate that a subpicture corresponds to a constituent rectangle, which is indicated through cr_subpics_partitioning_flag equal to 1. It is to be understood that embodiments are not limited to the concept of subpictures being available in the underlying video codec but can be similarly realized to any similar coding structure, such as tiles, tile groups, or rectangular slices. Furthermore, the above syntax and semantics presents is based on a one-to-one mapping between a subpicture and a constituent rectangle. It is to be understood that embodiments may be similarly realized by indicating multiple subpictures that comprise a single constituent rectangle.

The syntax may include a “global” syntax element (e.g., a flag) to indicate that each constituent rectangle is motion-constrained. The syntax may include a syntax element (e.g., a flag) per constituent rectangle to indicate if that constituent rectangle is motion-constrained. The per-rectangle syntax element may be conditioned to be present only if each constituent rectangle is not indicated to be motion-constrained by the “global” syntax element.

The syntax may indicate that each constituent rectangle corresponds to an integer count of complete data units, such as NAL units or OBUs. Alternatively or additionally, the syntax may indicate per constituent rectangle if that constituent rectangle an integer count of complete data units, such as NAL units or OBUs.

The constituent rectangles SEI message may comprise additional metadata to describe one or more constituent rectangles. Each piece of additional metadata may be associated to one or more constituent rectangles, wherein the association may be indicated in the constituent rectangles SEI message or inferred. The additional metadata may comprise, but may not be limited to, one or more of the following: video usability information (VUI) nested within the constituent rectangles SEI message; one or more SEI messages nested within the constituent rectangles SEI message. For example, an alpha channel information SEI message may be nested within the constituent rectangles SEI message and associated with a constituent rectangle.

In an embodiment, a constituent region nesting SEI message is defined. The constituent region nesting SEI message indicates one or more constituent regions, e.g. through their IDs, and includes one or more nested SEI messages. The nested SEI messages apply to the indicated constituent regions. For example, the constituent region nesting SEI message may contain multiview acquisition, multiview view position, depth representation, and/or alpha channel information SEI message, among others.

In an embodiment, when subpicture-based constituent regions are indicated in the constituent rectangles SEI message, an encoder may use a scalable nesting SEI message of VVC with indicated subpicture ID(s) to include SEI messages that apply to constituent region(s) corresponding to the indicated subpicture ID(s). Such use of the scalable nesting SEI message is enabled when sn_subpic_flag is equal to 1.

### Usages

Usages for an encoding system to pack constituent pictures into the same picture may include, but may not be limited to, one or more of the following:
Texture constituent picture and the related alpha map constituent picture
Texture constituent picture and the related depth map constituent picture
Two texture constituent pictures representing a stereoscopic pair and the two respective depth map constituent pictures
Texture constituent picture (optional) and the related object mask constituent picture(s). If there are several object mask constituent pictures that may be superimposed in an inferred or indicated z-order.
Feature map constituent pictures extracted from a source texture picture
Multi-plane texture pictures and the related alpha map constituent pictures. Each of the multi-plane texture pictures represents a certain distance from the camera.
Any of the usages above may be extended for multiple views, i.e., multiple different camera positions packed into the same picture.

Accordingly, aspects of the examples described herein include signaling position and size, allow reuse of subpics to avoid signaling of size and position and get parameters from subpic id with matching index, with implementation of a same size method with grid size signaled and derivation process, optional type description as text, optional rect id, optionally inferring rect type indicator from previously signalled value, for when all rectangles are the same type, can signal empty rect (especially useful for same size signalling, e.g. putting 3 rects in a 2×2 grid), and support for adaptive resolution change.

The examples described herein are applicable to applications which utilize (texture) video and depth, or video and alpha, or video and object mask, or multi-view video. The examples described herein are also applicable for applications targeted by the Feature Coding for Machines (FCM) project, in which image features can be encoded using video coding standards, such as VVC. The herein described SEI message may be included in a bitstream. The examples described herein are also related non-normative operations.

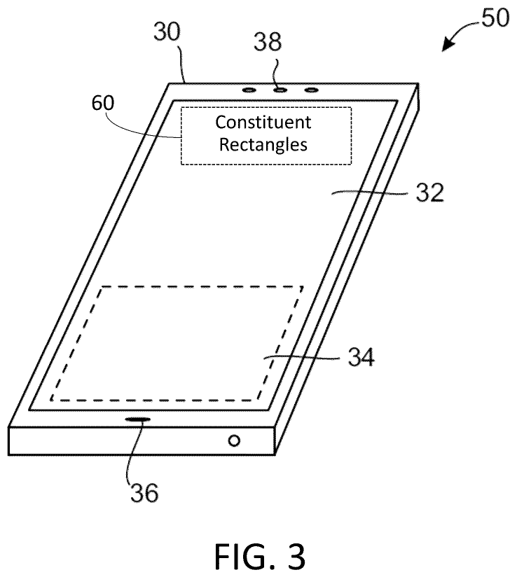

FIG. 3 shows a layout of an apparatus 50 according to an example embodiment. The apparatus 50 may for example be a mobile terminal or user equipment of a wireless communication system, a sensor device, a tag, or other lower power device. However, the embodiments of the examples described herein may be implemented within any electronic device or apparatus which may encode or decode multimedia content.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection. As shown in FIG. 3, constituent rectangles 60 may implement the examples described herein related to constituent rectangles.

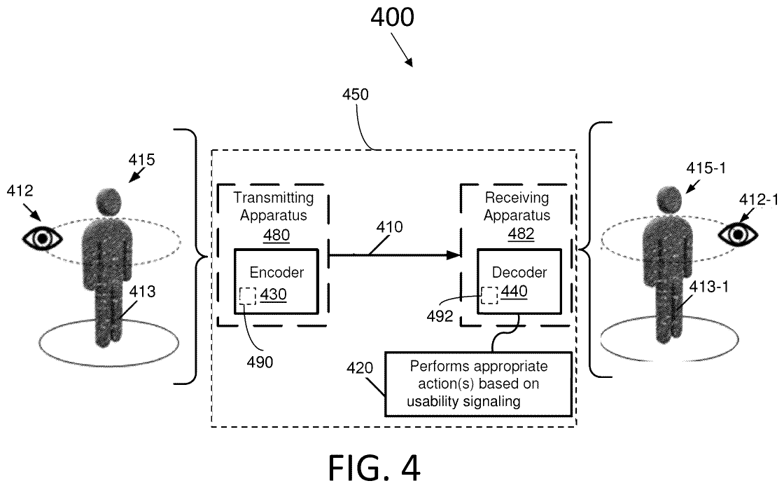

FIG. 4 is a block diagram illustrating a system 400 in accordance with several examples. In an example, the encoder 430 is used to encode an image or video from the scene 415, and the encoder 430 is implemented in a transmitting apparatus 480. The encoder 430 produces a bitstream 410 comprising signaling that is received by the receiving apparatus 482, which implements a decoder 440. The encoder 430 sends the bitstream 410 that comprises the herein described signaling. The decoder 440 forms the image or video for the scene 415-1, and the receiving apparatus 482 would present this to the user, e.g., via a smartphone, television, or projector among many other options.

In some examples, the transmitting apparatus 480 and the receiving apparatus 482 are at least partially within a common apparatus, and for example are located within a common housing 450. In other examples the transmitting apparatus 480 and the receiving apparatus 482 are at least partially not within a common apparatus and have at least partially different housings. Therefore in some examples, the encoder 430 and the decoder 440 are at least partially within a common apparatus, and for example are located within a common housing 450. For example the common apparatus comprising the encoder 430 and decoder 440 implements a codec. In other examples the encoder 430 and the decoder 440 are at least partially not within a common apparatus and have at least partially different housings, but when together still implement a codec.

In some examples, 3D media from the capture (e.g., volumetric capture) at a viewpoint 412 of the scene 415, which includes a person 413) is converted via projection to a series of 2D representations with occupancy, geometry, attributes and/or displacements. Additional atlas information is also included in the bitstream to enable inverse reconstruction. For decoding, the received bitstream 410 is separated into its components with atlas information; occupancy, geometry, displacement, and attribute 2D representations. A 3D reconstruction is performed to reconstruct the scene 415-1 created looking at the viewpoint 412-1 with a “reconstructed” person 413-1. The “−1” are used to indicate that these are reconstructions of the original. As indicated at 420, the decoder 440 performs an action or actions based on the received signaling.

Encoding 490 performs encoding of constituent rectangles based on the examples described herein. Decoding 492 performs decoding of constituent rectangles, based on the examples described herein.

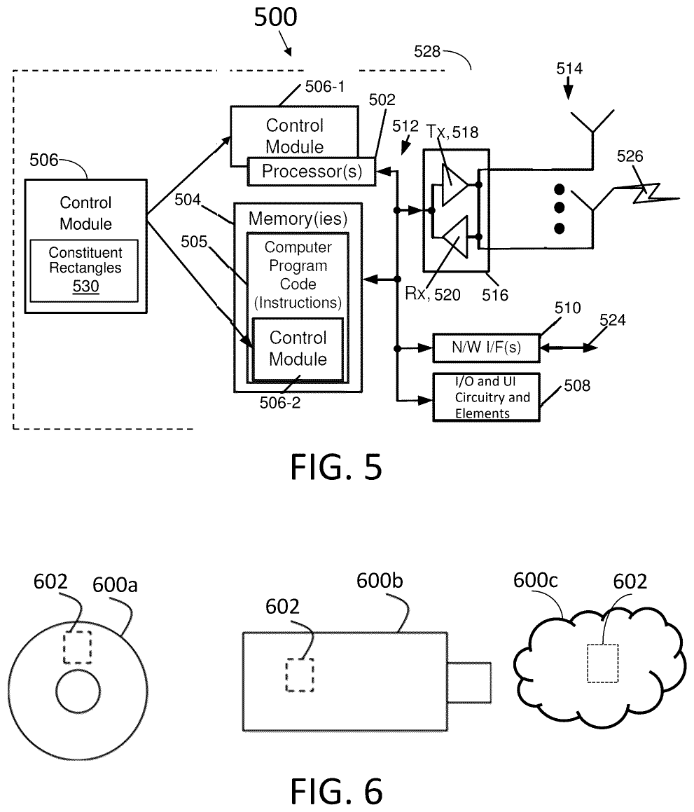

FIG. 5 is an example apparatus 500, which may be implemented in hardware, configured to implement the examples described herein. The apparatus 500 comprises at least one processor 502 (e.g., an FPGA and/or CPU), at least one memory 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein.

Apparatus 500 may be a smartphone, personal digital device or assistant, smart television, laptop, tablet, head-mounted display (HMD) or other user device or terminal device. The at least one memory 504 may be a non-transitory memory, a transitory memory, a volatile memory (e.g. RAM), or a non-volatile memory (e.g., ROM).

Constituent rectangles 530 implements the examples described herein related to encoding and decoding of constituent rectangles, based on the examples described herein.

The apparatus 500 includes a display and/or I/O interface 508, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de) modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the at least one processor 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the at least one processor 502. For instance, the at least one memory 504 store instructions that, when executed by the at least one processor 502, cause the apparatus 500 to perform one or more of the operations as described herein. Furthermore, the at least one processor 502, at least one memory 504, and example algorithms (e.g., as flowcharts and/or signaling diagrams), encoded as instructions, programs, or code, are means for causing performance of the operations described herein.

The apparatus 500 to implement the functionality of control module 506 may correspond to any of the apparatuses depicted herein. Alternatively, apparatus 500 and its elements may not correspond to any of the other apparatuses depicted herein, as apparatus 500 may be part of a self-organizing/optimizing network (SON) node or other node, such as a node in a cloud.

The apparatus 500 may also be distributed throughout the network including within and between apparatus 500 and any network element (such as a base station and/or terminal device and/or user equipment).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control module 506 may comprise object-oriented software configured to pass data or messages between objects within computer program code 505. Computer program code (e.g. instructions) 505, including control module 506 may comprise procedural, functional, or scripting code. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include common housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the operations of the methods described herein. Instructions and/or parameters 602 may represent or correspond to a non-transitory computer readable medium.

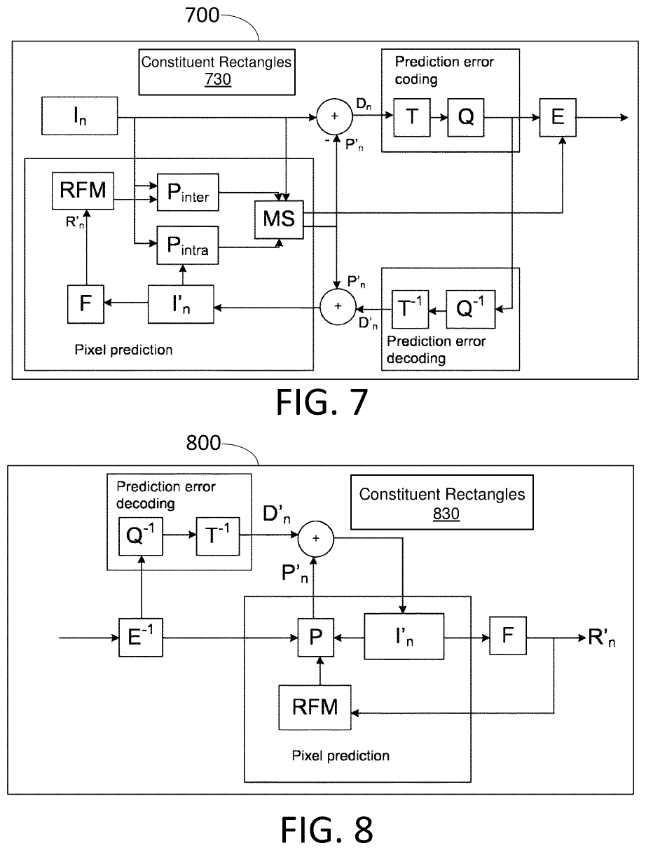

FIG. 7 shows an encoder 700 according to an embodiment. FIG. 7 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (B), a reference frame memory (RFM), inter prediction (p^{inter}), intra prediction (p^{intra}), mode selection (MS) and filtering (F). Constituent rectangles 730 implements the examples described herein related to encoding of constituent rectangles. FIG. 8 shows a decoder 800 according to an embodiment. FIG. 8 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Constituent rectangles 830 implements the examples described herein related to encoding of constituent rectangles.

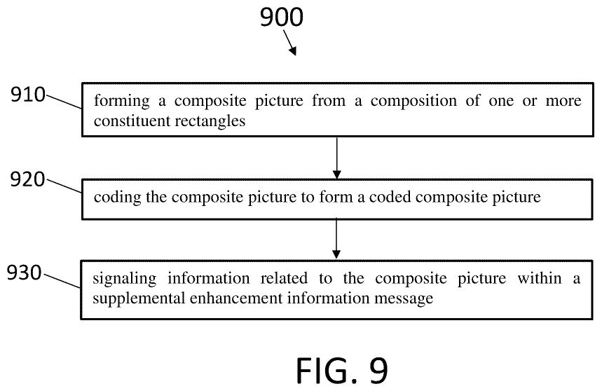

FIG. 9 is an example method 900, based on the examples described herein. At 910, the method includes forming a composite picture from a composition of one or more constituent rectangles. At 920, the method includes coding the composite picture to form a coded composite picture. At 930, the method includes signaling information related to the composite picture within a supplemental enhancement information message. Method 900 may be performed with apparatus 50, transmitting apparatus with encoder 430, apparatus 500, or encoder 700.

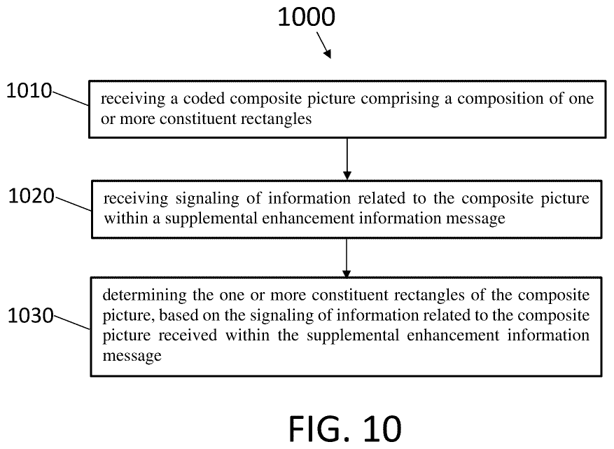

FIG. 10 is an example method 1000, based on the examples described herein. At 1010, the method includes receiving a coded composite picture comprising a composition of one or more constituent rectangles. At 1020, the method includes receiving signaling of information related to the composite picture within a supplemental enhancement information message. At 1030, the method includes determining or identifying the one or more constituent rectangles of the composite picture, based on the signaling of information related to the composite picture received within the supplemental enhancement information message. Method 1000 may be performed with apparatus 50, receiving apparatus 482 with decoder 440, apparatus 500, or decoder 800.

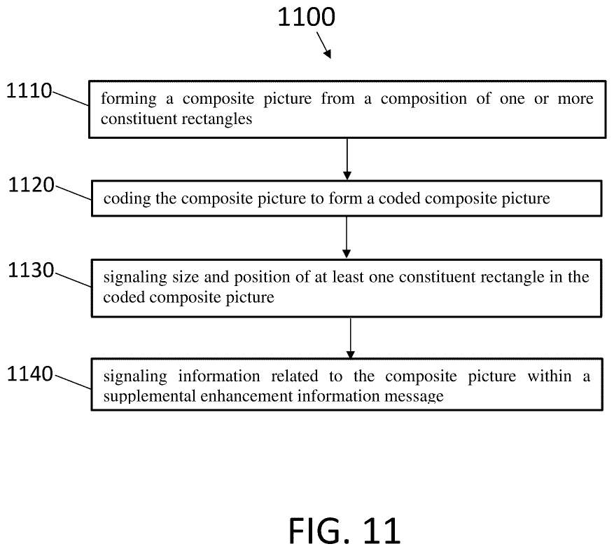

FIG. 11 is an example method 1100, based on the examples described herein. At 1110, the method 1100 includes forming a composite picture from a composition of one or more constituent rectangles. At 1120, the method 1100 includes coding the composite picture to form a coded composite picture. At 1130, the method 1100 includes signaling size and position of at least one constituent rectangle in the coded composite picture. At 1140, the method 1100 includes signaling information related to the composite picture within a supplemental enhancement information message. Method 1100 may be performed with apparatus 50, transmitting apparatus with encoder 430, apparatus 500, or encoder 700.

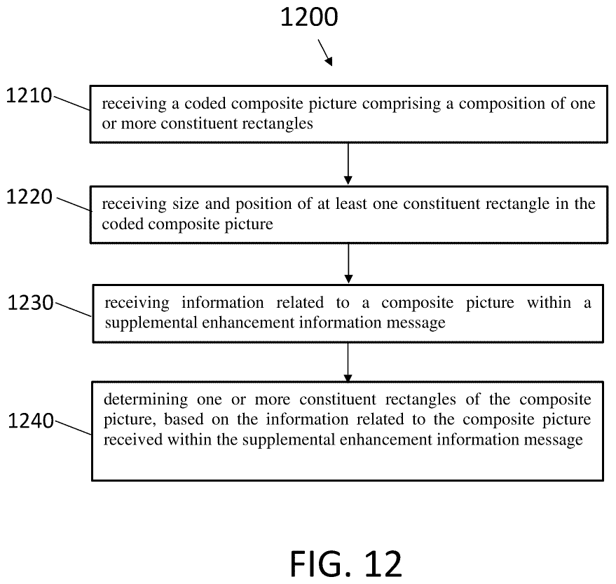

FIG. 12 is an example method 1200, based on the examples described herein. At 1210, the method 1200 includes receiving a coded composite picture comprising a composition of one or more constituent rectangles. At 1220, the method 1200 includes receiving size and position of at least one constituent rectangle in the coded composite picture. At 1230, the method 1200 includes receiving information related to a composite picture within a supplemental enhancement information message. At 1240, the method 1200 includes determining the one or more constituent rectangles of the composite picture, based on the information related to the composite picture received within the supplemental enhancement information message. Method 1200 may be performed with apparatus 50, receiving apparatus 482 with decoder 440, apparatus 500, or decoder 800.

The following examples are provided and described herein.

Example 1. An apparatus including: at least one processor; and at least one memory storing instructions that, when executed by the at least one processor, cause the apparatus at least to: form a composite picture from a composition of one or more constituent rectangles; code the composite picture to form a coded composite picture; and signal information related to the composite picture within a supplemental enhancement information message.

Example 2. The apparatus of example 1, wherein the instructions, when executed by the at least one processor, cause the apparatus at least to: signal size and position of at least one constituent rectangle in the coded composite picture.

Example 3. The apparatus of example 2, wherein: a unit size is signaled in luma samples; and the size and position of the at least one constituent rectangle is signaled in units of the unit size.

Example 4. The apparatus of any of examples 1 to 3, wherein the instructions, when executed by the at least one processor, cause the apparatus at least to: signal a subpicture partitioning flag that indicates whether subpicture partitioning parameters are used to determine sizes and positions of the constituent rectangles; wherein a value of 1 for the subpicture partitioning flag indicates that the subpicture partitioning parameters are used to determine the sizes and positions of the constituent rectangles; wherein a value of 0 for the subpicture partitioning flag indicates that the subpicture partitioning parameters are not used to determine the sizes and positions of the constituent rectangles.

Example 5. The apparatus of example 4, wherein: a constituent rectangle identifier is set equal to a subpicture index, when the subpicture partitioning flag has a value of 1.

Example 6. The apparatus of any of examples 1 to 5, wherein the instructions, when executed by the at least one processor, cause the apparatus at least to: signal a same size flag that indicates whether the constituent rectangles have the same size and are arranged in a grid pattern; wherein a value of 1 for the same size flag indicates that the constituent rectangles have the same size and are arranged in a grid pattern; and number of rows of a grid are signaled, and a number of columns of the grid are signaled; wherein a value of 0 for the same size flag indicates that sizes and positions of the constituent rectangles are allowed to differ.

Example 7. The apparatus of example 6, wherein: a top left horizontal position of a rectangle corresponding to an index is determined to be the index modulo the number of columns multiplied with a coded composite picture width divided with the number of columns, when the same size flag has a value of 1; a top left vertical position of the rectangle corresponding to the index is determined to be the index divided with the number of columns multiplied with a coded composite picture height divided with the number of rows, when the same size flag has a value of 1; a width of the rectangle corresponding to the index is determined to be the coded composite picture width divided with the number of columns, when the same size flag has a value of 1; and a height of the rectangle corresponding to the index is determined to be a coded composite picture height divided with the number of rows, when the same size flag has a value of 1.

Example 8. The apparatus of any of examples 1 to 7, wherein the instructions, when executed by the at least one processor, cause the apparatus at least to: for at least one constituent rectangle, signal text to indicate a description of the at least one constituent rectangle.

Example 9. The apparatus of any of examples 1 to 8, wherein the instructions, when executed by the at least one processor, cause the apparatus at least to: signal a flag to indicate whether an identifier is signaled for the constituent rectangles; signal an identifier of a constituent rectangle, in response to the flag being equal to 1; and determine to not signal the identifier of the constituent rectangle and infer its value to be an index of the constituent rectangle, in response to the flag not being equal to 1.

Example 10. The apparatus of any of examples 1 to 9, wherein a type is signaled for at least one constituent rectangle, where the type is one of texture, alpha, depth, object mask, or empty.

Example 11. The apparatus of example 10, wherein the instructions, when executed by the at least one processor, cause the apparatus at least to: signal an identifier of the at least one constituent rectangle, in response to a type of the at least one constituent rectangle comprising a type other than empty.

Example 12. The apparatus of any of examples 1 to 11, wherein a type is signaled for a first constituent rectangle, and a flag is signaled to indicate whether to signal a rectangle type indicator for a second constituent rectangle, with the flag set to 1 when the second constituent rectangle is the same type as the first constituent rectangle, and set to 0 when the second constituent rectangle is not the same type as the first constituent rectangle.

Example 13. The apparatus of any of examples 1 to 12, wherein the instructions, when executed by the at least one processor, cause the apparatus at least to: signal an empty rectangle, when a region of the composite picture corresponding to a signaled constituent rectangle position does not comprise information intended for any further usage by a receiving apparatus.

Example 14. The apparatus of any of examples 1 to 13, wherein the instructions, when executed by the at least one processor, cause the apparatus at least to: use adaptive picture resolution coding when coding the composite picture; signal a maximum picture dimensions and a current picture dimensions; and signal a flag that indicates whether a position and size of the constituent rectangles are with respect to the maximum picture dimensions or with respect to the current picture dimensions.

Example 15. The apparatus of any of examples 1 to 14, wherein the one or more constituent rectangles comprises multiple constituent pictures of the same content type, wherein a content type of a constituent rectangle is one of: texture, depth, alpha, or object mask.

Example 16. The apparatus of any of examples 1 to 15, wherein a first constituent rectangle comprises a first view of a multi-view scene, and a second first constituent rectangle comprises a second view of the multi-view scene.

Example 17. The apparatus of any of examples 1 to 16, wherein a first constituent rectangle comprises a first feature channel and a second first constituent rectangle comprises a second feature channel.

Example 18. The apparatus of any of examples 1 to 17, wherein the instructions, when executed by the at least one processor, cause the apparatus at least to: signal text that describes at least one constituent rectangle of the one or more constituent rectangles.

Example 19. The apparatus of any of examples 1 to 18, wherein the instructions, when executed by the at least one processor, cause the apparatus at least to: signal a content type per constituent rectangle.

Example 20. The apparatus of any of examples 1 to 19, wherein the instructions, when executed by the at least one processor, cause the apparatus at least to signal locations and sizes of the constituent rectangles through one of: subpicture parameters of a sequence parameter set without explicit signaling of the locations and sizes of the constituent rectangles and without explicit signaling of a unit size, or a number of columns and rows when the constituent rectangles are the same size, or explicit signaling in any order.

Example 21. The apparatus of any of examples 1 to 20, wherein the instructions, when executed by the at least one processor, cause the apparatus at least to: signal a flag indicating that a position and size of a constituent rectangle are with respect to a maximum width of a picture and a maximum height of the picture.

Example 22. The apparatus of any of examples 1 to 21, wherein the coded composite picture comprises at least one sample that is not in any of the constituent rectangles.

Example 23. The apparatus of any of examples 1 to 22, wherein the instructions, when executed by the at least one processor, cause the apparatus at least to: signal an empty rectangular type for a constituent rectangle comprising a vacant region.

Example 24. The apparatus of any of examples 1 to 23, wherein the instructions, when executed by the at least one processor, cause the apparatus at least to: signal a rectangle identifier per constituent rectangle.

Example 25. The apparatus of any of examples 1 to 24, wherein an identifier of a constituent rectangle is inferred to be an index corresponding to the constituent rectangle.

Example 26. The apparatus of any of examples 1 to 25, wherein the supplemental enhancement information message within which the information related to the composite picture is signaled persists for an entire coded layer video sequence.

Example 27. The apparatus of any of examples 1 to 26, wherein each of the constituent rectangles of the one or more constituent rectangles comprises an image.

Example 28. The apparatus of any of examples 1 to 27, wherein the information related to the composite picture formed from the composition of one or more constituent rectangles is signaled within the supplemental enhancement information message using at least one syntax element.

Example 29. An apparatus including: at least one processor; and at least one memory storing instructions that, when executed by the at least one processor, cause the apparatus at least to: receive a coded composite picture comprising a composition of one or more constituent rectangles; receive signaling of information related to the composite picture within a supplemental enhancement information message; and determine or identify the one or more constituent rectangles of the composite picture, based on the signaling of information related to the composite picture received within the supplemental enhancement information message.

Example 30. The apparatus of example 29, wherein the instructions, when executed by the at least one processor, cause the apparatus at least to: receive signaling of a size and position of at least one constituent rectangle in the coded composite picture.

Example 31. The apparatus of example 30, wherein: a unit size is signaled in luma samples; and the size and position of the at least one constituent rectangle is signaled in units of the unit size.

Example 32. The apparatus of any of examples 29 to 31, wherein the instructions, when executed by the at least one processor, cause the apparatus at least to: receive signaling of a subpicture partitioning flag that indicates whether subpicture partitioning parameters are used to determine sizes and positions of the constituent rectangles; wherein a value of 1 for the subpicture partitioning flag indicates that the subpicture partitioning parameters are used to determine the sizes and positions of the constituent rectangles; wherein a value of 0 for the subpicture partitioning flag indicates that the subpicture partitioning parameters are not used to determine the sizes and positions of the constituent rectangles.

Example 33. The apparatus of example 32, wherein a constituent rectangle identifier is set equal to a subpicture index, when the subpicture partitioning flag has a value of 1.

Example 34. The apparatus of any of examples 29 to 33, wherein the instructions, when executed by the at least one processor, cause the apparatus at least to: receive signaling of a same size flag that indicates whether the constituent rectangles have the same size and are arranged in a grid pattern; wherein a value of 1 for the same size flag indicates that the constituent rectangles have the same size and are arranged in a grid pattern, and a number of rows of a grid are signaled, and a number of columns of the grid are signaled; wherein a value of 0 for the same size flag indicates that sizes and positions of the constituent rectangles are allowed to differ.

Example 35. The apparatus of example 34, wherein the instructions, when executed by the at least one processor, cause the apparatus at least to: determine a top left horizontal position of a rectangle corresponding to an index to be the index modulo the number of columns multiplied with a composite picture width divided with the number of columns, in response to the same size flag having a value of 1; determine a top left vertical position of the rectangle corresponding to the index to be the index divided with the number of columns multiplied with a coded picture height divided with the number of rows, in response to the same size flag having a value of 1; determine a width of the rectangle corresponding to the index to be the coded composite picture width divided with the number of columns, in response to the same size flag having a value of 1; and determine a height of the rectangle corresponding to the index to be a coded composite picture height divided with the number of rows, in response to the same size flag having a value of 1.

Example 36. The apparatus of any of examples 29 to 35, wherein the instructions, when executed by the at least one processor, cause the apparatus at least to: for at least one constituent rectangle, receive signaling of text that indicates a description of the at least one constituent rectangle.

Example 37. The apparatus of any of examples 29 to 36, wherein the instructions, when executed by the at least one processor, cause the apparatus at least to: receive signaling of a flag that indicate whether an identifier is signaled for the constituent rectangles; and receive signaling of an identifier of a constituent rectangle, when the flag is equal to 1; wherein the identifier of the constituent rectangle is not signaled, and its value is inferred to be an index of the constituent rectangle, when the flag is not equal to 1.

Example 38. The apparatus of any of examples 29 to 37, wherein a type is signaled for at least one constituent rectangle, where the type is one of texture, alpha, depth, object mask, or empty.

Example 39. The apparatus of example 38, wherein the instructions, when executed by the at least one processor, cause the apparatus at least to: receive signaling of an identifier of the at least one constituent rectangle, when a type of the at least one constituent rectangle comprises a type other than empty.

Example 40. The apparatus of any of examples 29 to 39, wherein a type is signaled for a first constituent rectangle, and a flag is signaled to indicate whether to signal a rectangle type indicator for a second constituent rectangle, with the flag set to 1 when the second constituent rectangle is the same type as the first constituent rectangle, and set to 0 when the second constituent rectangle is not the same type as the first constituent rectangle.

Example 41. The apparatus of any of examples 29 to 40, wherein the instructions, when executed by the at least one processor, cause the apparatus at least to: receive signaling of an empty rectangle, when a region of the composite picture corresponding to a signaled constituent rectangle position does not comprise information intended for any further usage by the apparatus.

Example 42. The apparatus of any of examples 29 to 41, wherein the instructions, when executed by the at least one processor, cause the apparatus at least to: receive signaling of a maximum picture dimensions and a current picture dimensions; wherein adaptive picture resolution coding is used when coding the packed picture; and receive signaling of a flag that indicates whether a position and size of the constituent rectangles are with respect to the maximum picture dimensions or with respect to the current picture dimensions.

Example 43. The apparatus of any of examples 29 to 42, wherein the one or more constituent rectangles comprises multiple constituent pictures of the same content type, wherein a content type of a constituent rectangle is one of: texture, depth, alpha, or object mask.

Example 44. The apparatus of any of examples 29 to 43, wherein a first constituent rectangle comprises a first view of a multi-view scene, and a second first constituent rectangle comprises a second view of the multi-view scene.

Example 45. The apparatus of any of examples 29 to 44, wherein a first constituent rectangle comprises a first feature channel and a second first constituent rectangle comprises a second feature channel.

Example 46. The apparatus of any of examples 29 to 45, wherein the instructions, when executed by the at least one processor, cause the apparatus at least to: receive signaling of text that describes at least one constituent rectangle of the one or more constituent rectangles.

Example 47. The apparatus of any of examples 29 to 46, wherein the instructions, when executed by the at least one processor, cause the apparatus at least to: receive signaling of a content type per constituent rectangle; and determine or identify the one or more constituent rectangles of the composite picture, based on the signaling of the content type per constituent rectangle.

Example 48. The apparatus of any of examples 29 to 47, wherein the instructions, when executed by the at least one processor, cause the apparatus at least to receive signaling of locations and sizes of the one or more constituent rectangles through one of: subpicture parameters of a sequence parameter set without explicit signaling of the locations and sizes of the constituent rectangles and without explicit signaling of a unit size, or a number of columns and rows when the constituent rectangles are the same size, or explicit signaling in any order; and determine or identify the one or more constituent rectangles of the composite picture, based on the signaling of locations and sizes of the one or more constituent rectangles.

Example 49. The apparatus of any of examples 29 to 48, wherein the instructions, when executed by the at least one processor, cause the apparatus at least to: receive signaling of a flag indicating that a position and size of a constituent rectangle are with respect to a maximum width of a picture and a maximum height of a picture; and determine a position of a luma sample in a constituent rectangle based on the maximum width of the picture and the maximum height of the picture, and determine a width and height of the luma sample in the constituent rectangle based on the maximum width of the picture, the maximum height of the picture, and dimensions of the coded composite picture, in response to the flag indicating that the position and size of the constituent rectangle are with respect to the maximum width of the picture and a maximum height of the picture.

Example 50. The apparatus of any of examples 29 to 49, wherein the coded composite picture comprises at least one sample that is not in any of the constituent rectangles.

Example 51. The apparatus of any of examples 29 to 50, wherein the instructions, when executed by the at least one processor, cause the apparatus at least to: receive signaling of an empty rectangular type for a constituent rectangle comprising a vacant region; and determine or identify the one or more constituent rectangles of the composite picture, based on the signaling of the empty rectangular type for the constituent rectangle comprising the vacant region.

Example 52. The apparatus of any of examples 29 to 51, wherein the instructions, when executed by the at least one processor, cause the apparatus at least to: receive signaling of a rectangle identifier per constituent rectangle; and determine or identify the one or more constituent rectangles of the composite picture, based on the signaling of the rectangle identifier per constituent rectangle.

Example 53. The apparatus of any of examples 29 to 52, wherein the instructions, when executed by the at least one processor, cause the apparatus at least to: infer an identifier of a constituent rectangle to be an index corresponding to the constituent rectangle.

Example 54. The apparatus of any of examples 29 to 53, wherein the supplemental enhancement information message within which the information related to the composite picture comprising the composition of one or more constituent rectangles is signaled persists for an entire coded layer video sequence.

Example 55. The apparatus of any of examples 29 to 54, wherein each of the constituent rectangles of the one or more constituent rectangles comprises an image.

Example 56. The apparatus of any of examples 29 to 55, wherein the information related to the composite picture comprising the composition of one or more constituent rectangles is signaled within the supplemental enhancement information message using at least one syntax element.

Example 57. A method including: forming a composite picture from a composition of one or more constituent rectangles; coding the composite picture to form a coded composite picture; and signaling information related to the composite picture within a supplemental enhancement information message.

Example 58. A method including: receiving a coded composite picture comprising a composition of one or more constituent rectangles; receiving signaling of information related to the composite picture within a supplemental enhancement information message; and determining the one or more constituent rectangles of the composite picture, based on the signaling of information related to the composite picture received within the supplemental enhancement information message.

Example 59. An apparatus including: means for forming a composite picture from a composition of one or more constituent rectangles; means for coding the composite picture to form a coded composite picture; and means for signaling information related to the composite picture within a supplemental enhancement information message.

Example 60. An apparatus including: means for receiving a coded composite picture comprising a composition of one or more constituent rectangles; means for receiving signaling of information related to the composite picture within a supplemental enhancement information message; and means for determining the one or more constituent rectangles of the composite picture, based on the signaling of information related to the composite picture received within the supplemental enhancement information message.

Example 61. A computer readable medium including instructions stored thereon for performing at least the following: forming a composite picture from a composition of one or more constituent rectangles; coding the composite picture to form a coded composite picture; and signaling information related to the composite picture within a supplemental enhancement information message.

Example 62. A computer readable medium including instructions stored thereon for performing at least the following: receiving a coded composite picture comprising a composition of one or more constituent rectangles; receiving signaling of information related to the composite picture within a supplemental enhancement information message; and determining the one or more constituent rectangles of the composite picture, based on the signaling of information related to the composite picture received within the supplemental enhancement information message.

Example 63. An apparatus comprising: at least one processor; and at least one memory storing instructions that, when executed by the at least one processor, cause the apparatus at least to perform: forming a composite picture from a composition of one or more constituent rectangles; coding the composite picture to form a coded composite picture; signaling size and position of at least one constituent rectangle in the coded composite picture; and signaling information related to the composite picture within a supplemental enhancement information message.

Example 64. The apparatus of example 63, wherein: a unit size is signaled in luma samples; and the size and position of the at least one constituent rectangle is signaled in units of the unit size.

Example 65. The apparatus of example 63, wherein the instructions, when executed by the at least one processor, cause the apparatus at least to perform: signaling a subpicture partitioning indicator that indicates whether subpicture partitioning parameters are used to determine sizes and positions of one or more constituent rectangles; wherein a first value for the subpicture partitioning indicator indicates that the subpicture partitioning parameters are used to determine the sizes and positions of the one or more constituent rectangles; and wherein a second value for the subpicture partitioning indicator indicates that the subpicture partitioning parameters are not used to determine the sizes and positions of the one or more constituent rectangles. In an example, the first value comprises or is equal to one and the second value comprises or is equal to zero.

Example 66. The apparatus of example 65, wherein: a constituent rectangle identifier is set equal to a subpicture index, when the subpicture partitioning indicator comprises the first value.

Example 67. The apparatus of example 63, wherein the instructions, when executed by the at least one processor, cause the apparatus at least to perform: signaling a same size indicator that indicates whether one or more constituent rectangles have the same size and are arranged in a grid pattern; wherein a first value for the same size indicator indicates that the one or more constituent rectangles have the same size and are arranged in the grid pattern; and number of rows of a grid are signaled, and a number of columns of the grid are signaled; and wherein a second value for the same size indicator indicates that sizes and positions of the one or more constituent rectangles are allowed to differ. In an example, the first value comprises or is equal to one and the second value comprises or is equal to zero.

Example 68. The apparatus of example 67, wherein: a top left horizontal position of a rectangle corresponding to an index is determined to be the index modulo the number of columns multiplied with a coded composite picture width divided with the number of columns, when the same size indicator has the first value; a top left vertical position of the rectangle corresponding to the index is determined to be the index divided with the number of columns multiplied with a coded composite picture height divided with the number of rows, when the same size indicator has the first value; a width of the rectangle corresponding to the index is determined to be the coded composite picture width divided with the number of columns, when the same size indicator has the first value; and a height of the rectangle corresponding to the index is determined to be the coded composite picture height divided with the number of rows, when the same size indicator has the first value.

Example 69. The apparatus of example 63, wherein the instructions, when executed by the at least one processor, cause the apparatus at least to perform: for the at least one constituent rectangle, signaling text to indicate a description of the at least one constituent rectangle.

Example 70. The apparatus of example 63, wherein the instructions, when executed by the at least one processor, cause the apparatus at least to perform: signaling an identifier indicator to indicate whether an identifier is signaled for one or more constituent rectangles; signaling an identifier of a constituent rectangle, in response to the identifier being equal to a first value; and determining to not signal the identifier of the constituent rectangle and infer a value of the identifier to be an index of the constituent rectangle, in response to the identifier indicator not being equal to the first value. In an example, the first value comprises or is equal to one and the second value comprises or is equal to zero.

Example 71. The apparatus of example 63, wherein the instructions, when executed by the at least one processor, cause the apparatus at least to perform: signaling an identifier of the at least one constituent rectangle, in response to a type of the at least one constituent rectangle comprising a type other than empty.

Example 72. The apparatus of example 63, wherein the instructions, when executed by the at least one processor, cause the apparatus at least to perform: signaling an empty rectangle, when a region of the composite picture corresponding to a signaled constituent rectangle position does not comprise information intended for any further usage by a receiving apparatus.

Example 73. The apparatus of example 63, wherein the instructions, when executed by the at least one processor, cause the apparatus at least to perform: using adaptive picture resolution coding when coding the composite picture; signaling a maximum picture dimensions and a current picture dimensions; and signaling a size and position indicator for indicating whether the position and size of one or more constituent rectangles are with respect to the maximum picture dimensions or with respect to the current picture dimensions.

Example 74. The apparatus of example 63, wherein the instructions, when executed by the at least one processor, cause the apparatus at least to perform: signaling a content type per constituent rectangle.

Example 75. The apparatus of example 63, wherein the instructions, when executed by the at least one processor, cause the apparatus at least to perform: signaling locations and sizes of one or more constituent rectangles through one of: subpicture parameters of a sequence parameter set without explicit signaling of the locations and sizes of the one or more constituent rectangles and without explicit signaling of a unit size, or a number of columns and rows when the one or more constituent rectangles are the same size, or explicit signaling in any order.

Example 76. An apparatus comprising: at least one processor; and at least one memory storing instructions that, when executed by the at least one processor, cause the apparatus at least to perform: receiving a coded composite picture comprising a composition of one or more constituent rectangles; receiving of a size and position of at least one constituent rectangle in the coded composite picture; receiving information related to a composite picture within a supplemental enhancement information message; and determining one or more constituent rectangles of the composite picture, based on the information related to the composite picture received within the supplemental enhancement information message.

Example 77. The apparatus of example 76, wherein: a unit size is signaled in luma samples; and the size and position of the at least one constituent rectangle is signaled in units of the unit size.

Example 78. The apparatus of example 76, wherein the instructions, when executed by the at least one processor, cause the apparatus at least to perform: receiving a subpicture partitioning indicator that indicates whether subpicture partitioning parameters are used to determine sizes and positions of the one or more constituent rectangles; wherein a first value for the subpicture partitioning indicator indicates that the subpicture partitioning parameters are used to determine the sizes and positions of the one or more constituent rectangles; and wherein a second value the subpicture partitioning indicator indicates that the subpicture partitioning parameters are not used to determine the sizes and positions of the one or more constituent rectangles. In an example, the first value comprises or is equal to one and the second value comprises or is equal to zero.

Example 79. The apparatus of example 78, wherein a constituent rectangle identifier is set equal to a subpicture index, when the subpicture partitioning indicator has the first value.

Example 80. The apparatus of example 76, wherein the instructions, when executed by the at least one processor, cause the apparatus at least to perform: receiving a same size indicator that indicates whether the one or more constituent rectangles have the same size and are arranged in a grid pattern; wherein a first value for the same size flag indicator that the one or more constituent rectangles have the same size and are arranged in the grid pattern, and a number of rows of a grid are signaled, and a number of columns of the grid are signaled; and wherein a second value for the same size indicator indicates that sizes and positions of the one or more constituent rectangles are allowed to differ. In an example, the first value comprises or is equal to one and the second value comprises or is equal to zero.

Example 81. A method comprising: forming a composite picture from a composition of one or more constituent rectangles; coding the composite picture to form a coded composite picture; signaling size and position of at least one constituent rectangle in the coded composite picture; and signaling information related to the composite picture within a supplemental enhancement information message.

Example 82. A method comprising: receiving a coded composite picture comprising a composition of one or more constituent rectangles; receiving size and position of at least one constituent rectangle in the coded composite picture; receiving information related to a composite picture within a supplemental enhancement information message; and determining one or more constituent rectangles of the composite picture, based on the information related to the composite picture received within the supplemental enhancement information message.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
AI artificial intelligence
AMVP advanced motion vector prediction
ASIC application specific integrated circuit
Aux auxiliary
AVC advanced video coding
CLVS coded layer video sequence
Cols columns
CPU central processing unit
cr constituent rectangle
CTU coding tree unit
Exp exponential
FCM feature coding for machines
f(n) fixed-value bit string using n bits written (from left to right) with the left bit first (e.g. f(1))
FPGA field programmable gate array
H.2xx family of video coding standards in the domain of the ITU-T (e.g. H.264, H.265, H.266, H.274)
HEVC high efficiency video coding
HMD head-mounted display
HW hardware
ID identifier
Idc indicator
IEC International Electrotechnical Commission
I/F interface
I/O input/output
ISO International Organization for Standardization
ITU International Telecommunication Union
ITU-T ITU Telecommunication Standardization Sector
MCTS motion constrained tile set
NAL network abstraction layer
N/W network
OBU open bitstream unit
PPS picture parameter set
RAM random access memory
Rect rectangle
RFM reference frame memory
ROM read only memory
SEI supplemental enhancement information
SON self-organizing/optimizing network
SPS sequence parameter set
SPT subpicture type
st (v) string using a variable number of bits
TMVP temporal motion vector prediction
ue(v) unsigned integer Exp-Golomb-coded syntax element with the left bit first
UI user interface
u(n) unsigned integer using n bits (e.g. u(4))
USB universal serial bus
u(v) unsigned integer using a variable number of bits
V3C visual volumetric video-based coding
VPS video parameter set
VSEI versatile supplemental enhancement information
VUI video usability information
VVC versatile video coding

What is claimed is:

1. An apparatus comprising:
at least one processor; and
at least one memory storing instructions that, when executed by the at least one processor, cause the apparatus at least to perform:
forming a composite picture from a composition of one or more constituent rectangles;
coding the composite picture to form a coded composite picture;
signaling size and position of at least one constituent rectangle in the coded composite picture; and
signaling information related to the composite picture within a supplemental enhancement information message.

2. The apparatus of claim 1, wherein:
a unit size is signaled in luma samples; and
the size and position of the at least one constituent rectangle is signaled in units of the unit size.

3. The apparatus of claim 1, wherein the instructions, when executed by the at least one processor, cause the apparatus at least to perform:
signaling a subpicture partitioning indicator that indicates whether subpicture partitioning parameters are used to determine sizes and positions of one or more constituent rectangles;
wherein a first value for the subpicture partitioning indicator indicates that the subpicture partitioning parameters are used to determine the sizes and positions of the one or more constituent rectangles; and
wherein a second value for the subpicture partitioning indicator indicates that the subpicture partitioning parameters are not used to determine the sizes and positions of the one or more constituent rectangles.

4. The apparatus of claim 3, wherein:
a constituent rectangle identifier is set equal to a subpicture index, when the subpicture partitioning indicator comprises the first value.

5. The apparatus of claim 1, wherein the instructions, when executed by the at least one processor, cause the apparatus at least to perform:
signaling a same size indicator that indicates whether one or more constituent rectangles have the same size and are arranged in a grid pattern;
wherein a first value for the same size indicator indicates that the one or more constituent rectangles have the same size and are arranged in the grid pattern; and number of rows of a grid are signaled, and a number of columns of the grid are signaled; and
wherein a second value for the same size indicator indicates that sizes and positions of the one or more constituent rectangles are allowed to differ.

6. The apparatus of claim 5, wherein:
a top left horizontal position of a rectangle corresponding to an index is determined to be the index modulo the number of columns multiplied with a coded composite picture width divided with the number of columns, when the same size indicator has the first value;
a top left vertical position of the rectangle corresponding to the index is determined to be the index divided with the number of columns multiplied with a coded composite picture height divided with the number of rows, when the same size indicator has the first value;
a width of the rectangle corresponding to the index is determined to be the coded composite picture width divided with the number of columns, when the same size indicator has the first value; and
a height of the rectangle corresponding to the index is determined to be the coded composite picture height divided with the number of rows, when the same size indicator has the first value.

7. The apparatus of claim 1, wherein the instructions, when executed by the at least one processor, cause the apparatus at least to perform:
for the at least one constituent rectangle, signaling text to indicate a description of the at least one constituent rectangle.

8. The apparatus of claim 1, wherein the instructions, when executed by the at least one processor, cause the apparatus at least to perform:
signaling an identifier indicator to indicate whether an identifier is signaled for one or more constituent rectangles;
signaling an identifier of a constituent rectangle, in response to the identifier being equal to a first value; and
determining to not signal the identifier of the constituent rectangle and infer a value of the identifier to be an index of the constituent rectangle, in response to the identifier indicator not being equal to the first value.

9. The apparatus of claim 1, wherein the instructions, when executed by the at least one processor, cause the apparatus at least to perform:
signaling an identifier of the at least one constituent rectangle, in response to a type of the at least one constituent rectangle comprising a type other than empty.

10. The apparatus of claim 1, wherein the instructions, when executed by the at least one processor, cause the apparatus at least to perform:
signaling an empty rectangle, when a region of the composite picture corresponding to a signaled constituent rectangle position does not comprise information intended for any further usage by a receiving apparatus.

11. The apparatus of claim 1, wherein the instructions, when executed by the at least one processor, cause the apparatus at least to perform:
using adaptive picture resolution coding when coding the composite picture;
signaling a maximum picture dimensions and a current picture dimensions; and
signaling a size and position indicator for indicating whether the position and size of one or more constituent rectangles are with respect to the maximum picture dimensions or with respect to the current picture dimensions.

12. The apparatus of claim 1, wherein the instructions, when executed by the at least one processor, cause the apparatus at least to perform:
signaling a content type per constituent rectangle.

13. The apparatus of claim 1, wherein the instructions, when executed by the at least one processor, cause the apparatus at least to perform: signaling locations and sizes of one or more constituent rectangles through one of:
subpicture parameters of a sequence parameter set without explicit signaling of the locations and sizes of the one or more constituent rectangles and without explicit signaling of a unit size, or
a number of columns and rows when the one or more constituent rectangles are the same size, or
explicit signaling in any order.

14. An apparatus comprising:
at least one processor; and
at least one memory storing instructions that, when executed by the at least one processor, cause the apparatus at least to perform:
receiving a coded composite picture comprising a composition of one or more constituent rectangles;
receiving of a size and position of at least one constituent rectangle in the coded composite picture;
receiving information related to a composite picture within a supplemental enhancement information message; and
determining one or more constituent rectangles of the composite picture, based on the information related to the composite picture received within the supplemental enhancement information message.

15. The apparatus of claim 14, wherein:
a unit size is signaled in luma samples; and
the size and position of the at least one constituent rectangle is signaled in units of the unit size.

16. The apparatus of claim 14, wherein the instructions, when executed by the at least one processor, cause the apparatus at least to perform:
receiving a subpicture partitioning indicator that indicates whether subpicture partitioning parameters are used to determine sizes and positions of the one or more constituent rectangles;
wherein a first value for the subpicture partitioning indicator indicates that the subpicture partitioning parameters are used to determine the sizes and positions of the one or more constituent rectangles; and
wherein a second value the subpicture partitioning indicator indicates that the subpicture partitioning parameters are not used to determine the sizes and positions of the one or more constituent rectangles.

17. The apparatus of claim 16, wherein a constituent rectangle identifier is set equal to a subpicture index, when the subpicture partitioning indicator has the first value.

18. The apparatus of claim 14, wherein the instructions, when executed by the at least one processor, cause the apparatus at least to perform:
receiving a same size indicator that indicates whether the one or more constituent rectangles have the same size and are arranged in a grid pattern;
wherein a first value for the same size flag indicator that the one or more constituent rectangles have the same size and are arranged in the grid pattern, and a number of rows of a grid are signaled, and a number of columns of the grid are signaled; and
wherein a second value for the same size indicator indicates that sizes and positions of the one or more constituent rectangles are allowed to differ.

19. A method comprising:
forming a composite picture from a composition of one or more constituent rectangles;
coding the composite picture to form a coded composite picture;
signaling size and position of at least one constituent rectangle in the coded composite picture; and
signaling information related to the composite picture within a supplemental enhancement information message.

20. A method comprising:
receiving a coded composite picture comprising a composition of one or more constituent rectangles;
receiving size and position of at least one constituent rectangle in the coded composite picture;
receiving information related to a composite picture within a supplemental enhancement information message; and
determining one or more constituent rectangles of the composite picture, based on the information related to the composite picture received within the supplemental enhancement information message.
